(19) United States
(12) Patent Application Publication
(10) Pub. No.: US 2018/0055037 A1
(43) Pub. Date: Mar. 1, 2018

(54) Child And Pet Secured Poison-Free Rodent Trap

(71) Applicant: Camro Aps, Norager (DK)

(72) Inventor: Kurt Sorensen, Norager (DK)

(21) Appl. No.: 15/687,765

(22) Filed: Aug. 28, 2017

(30) Foreign Application Priority Data
Sep. 1, 2016 (EP) 16186805.4

(51) Int. Cl. A01M 23/24; A01M 23/38

(52) U.S. Cl. CPC A01M 23/24; A01M 23/38

(57) ABSTRACT

The present invention relates to the field of poison-free traps for rats and mice, and in particular relates to traps for use on the ground. The poison-free rat and/or mouse trap of the present invention comprises a) a housing with a rat and/or mouse entry opening positioned in the side wall and/or in the bottom wall; and b) a mechanical and/or electrical killing device positioned within the housing. The killing means of the mechanical and/or electrical killing device is positioned at a level above the level of the rat and/or mouse entry opening, and wherein at least a part of the rat and/or mouse entry opening is lined with one or more rows of serrated protrusions.

### TECHNICAL FIELD OF THE INVENTION

The present invention relates to the field of traps for rats and mice, and in particular relates to traps for use on the ground.

### BACKGROUND OF THE INVENTION

A number of traps are known in the art. Types are known using poison for killing rodents, and further a number of traps are known that are poison free. The poison-free traps generally fall in two categories, these being mechanical traps and electrical traps.

Traditional traps have the disadvantage that it is easy for larger pets, a child, or even a curious adult to trigger the killing means with the paw/hand, thereby causing accidents.

### OBJECT OF THE INVENTION

The objective of the present invention is to provide a poison-free trap in which it is very difficult, or preferably impossible, to trigger the killing means with the paw/hand.

### DESCRIPTION OF THE INVENTION

A first aspect of the present invention relates to a poison-free rat and/or mouse trap for placement on the ground, the poison-free trap comprising:
a housing with a rat and/or mouse entry opening positioned in the side wall and/or in the bottom wall; and
a mechanical and/or electrical killing device positioned within the housing;
   wherein the killing means of the mechanical and/or electrical killing device is positioned at a level above the level of the rat and/or mouse entry opening, and
   wherein at least a part of the rat and/or mouse entry opening is lined with one or more rows of serrated protrusions.

A second aspect of the present invention relates to a poison-free rat and/or mouse trap for placement on the ground, the poison-free trap comprising:
a housing with a rat and/or mouse entry opening positioned in the side wall and/or in the bottom wall; and
a mechanical and/or electrical killing device positioned within the housing;
   wherein at least a part of the rat and/or mouse entry opening is lined with one or more rows of serrated protrusions.

When a larger pet, a child, or even a curious adult tries to force the paw/hand through the rat and/or mouse entry opening, the response of withdrawal is immediate due to the unpleasant palpable sensation of the serrated protrusions, thereby avoiding that the paw/hand reaches the killing means.

The use of the term “serrated” or “serrations” in this disclosure will generally be used to refer to an object having teeth, ridges, peaks, points, projections and/or protrusions extending from the surface thereof. These serrations can be of any shape, preferably having points or sharp edges. Further, although a serration is generally referred to as extending from a surface, one of skill in the art would recognize that a serration may be formed by removing portions of a surface to form valleys, troughs or the like resulting in the creation of corresponding serrations extending from a new surface.

Electrical traps are characterised by the killing mechanism being an electrical shock device almost instantly killing the rodent. Mechanical traps are characterised by killing means that strikes the rodent and almost instantly kills the rodent. The killing means in mechanical traps are normally spring driven or gas pressure driven.

In one or more embodiments, the bottom wall of the housing is configured as an open-ended tunnel, the tunnel being configured and sized to allow a rat and/or mouse to pass from one end to the other; wherein the rat and/or mouse entry opening is positioned a1) in the side wall and/or a2) in an open end, and b) in the upper wall of the open-ended tunnel. The open-ended configuration allows the rat and/or mouse to see through the tunnel to the other side of the trap, whereby it will not hesitate entering the trap.

In one or more embodiments, the open-ended tunnel is configured with an open bottom, such that a rat and/or mouse within the open-ended tunnel is walking on the ground on which the poison-free trap is positioned. This configuration makes the rat and/or mouse to feel more safe, and thereby more prone to stay within the open-ended tunnel.

In one or more embodiments, the entry opening is positioned in both the side wall and in an open end of the open-ended tunnel. This configuration makes it easier for the killed rat and/or mouse to fall out of the trap, such that a predator, e.g. a fox, can remove it from the trap.

In one or more embodiments, the killing means of the mechanical and/or electrical killing device is positioned at a level above the level of the rat and/or mouse entry opening such that the rat and/or mouse can reach the killing means when standing within the housing on their hind legs. This configuration increases the number of times that a rat and/or mouse entering the trap will encounter the killing means.

The dimensions of the rat and/or mouse entry opening are important. A narrow entry opening below 40 mm will partly solve the problem with reaching the killing means, however, a rat is not prone to not enter such a narrow entry opening.

In one or more embodiments, the rat and/or mouse entry opening and the one or more rows of serrated protrusions are sized and configured to leave an opening with a free height of at least 40 mm, such as within the range of 40-100 mm, e.g. at least 45 mm, such as within the range of 45-95 mm, e.g. at least 50 mm, such as within the range of 50-90 mm, e.g. at least 55 mm, such as within the range of 55-85 mm, e.g. at least 60 mm, such as within the range of 60-80 mm, e.g. at least 65 mm, such as within the range of 70-75 mm, e.g. at least 70 mm.

In one or more embodiments, the rat and/or mouse entry opening and the one or more rows of serrated protrusions are sized and configured to leave an opening with a clear width of at least 40 mm, such as within the range of 40-100 mm, e.g. at least 45 mm, such as within the range of 45-95 mm, e.g. at least 50 mm, such as within the range of 50-90 mm, e.g. at least 55 mm, such as within the range of 55-85 mm, e.g. at least 60 mm, such as within the range of 60-80 mm, e.g. at least 65 mm, such as within the range of 70-75 mm, e.g. at least 70 mm.

In one or more embodiments, at least the top entrance section of the rat and/or mouse entry opening is lined with one or more rows of serrated protrusions. This position is important, as the paw/hand of an “intruder” will seek upwards.

In one or more embodiments, the trap comprises means for securing the housing to the ground and/or to a wall near the ground, to avoid that the trap can be turned on its side. Such means may be bolts or earth anchors.

In one or more embodiments, a part of the side wall is configured as a door with a lock for restricted access to the killing device located within the housing.

Advantageously the killing device is a gas cartridge operated device. Such device has shown to be appropriate for such installation. Other types of killing devices may however also be used without limiting the scope of the invention.

The gas cartridge operated device, as well as other non-electrical devices, has the advantage of being usable in APEX areas without the risk of igniting gas or flammable fluid.

Advantageously a signal indicating the activation of the killing device is transmitted wirelessly to a receiving device. Hereby electrical connections between the killing device and a communication device, placed at a distance from the killing device, may be avoided. The communication device eventually has a radio module enabling the device to send SMS messages to a computer.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 is a perspective view of a poison-free rat and/or mouse trap in accordance with various embodiments of the invention;

FIG. 2 is a side view of a poison-free rat and/or mouse trap in accordance with various embodiments of the invention, where a side wall of the housing has been removed;

FIG. 3 is a perspective view of a poison-free rat and/or mouse trap in accordance with various embodiments of the invention, where a side wall of the housing has been removed; and

FIG. 4 is a perspective view of a bottom wall of the housing configured as an open-ended tunnel.

### REFERENCES

100 Poison-free rat and/or mouse trap
200 Housing
210 Rat and/or mouse entry opening
212 Serrated protrusions
220 Side wall
222 Door
230 Bottom wall
232 Side wall
234 Open end
236 Upper wall
300 Mechanical and/or electrical killing device
310 Killing means

### DETAILED DESCRIPTION OF THE INVENTION

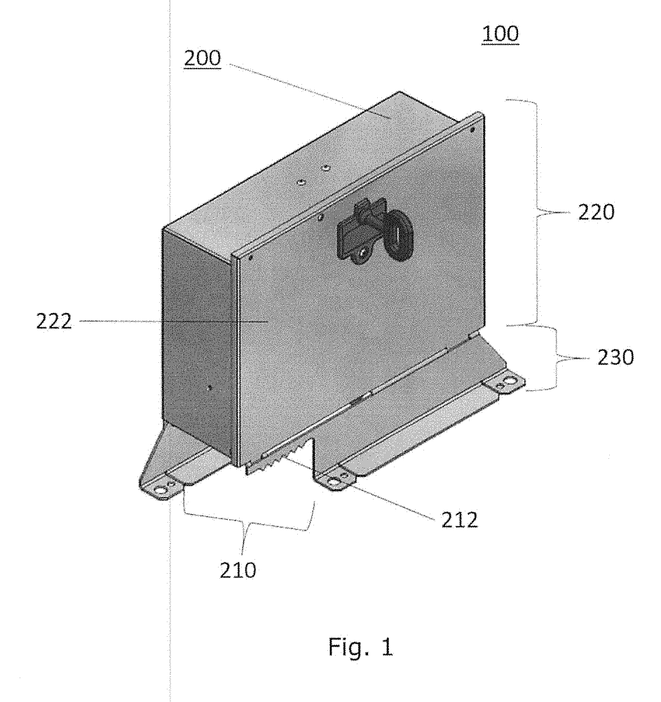

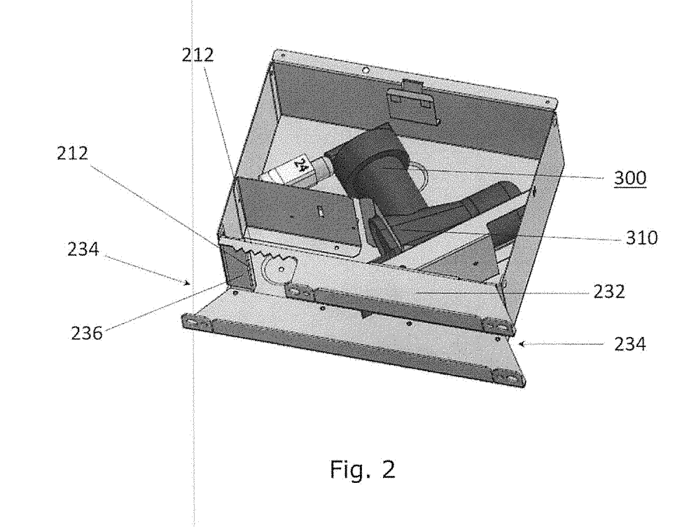

FIG. 1 is a perspective view of a poison-free rat and/or mouse trap in accordance with various embodiments of the invention. The poison-free rat and/or mouse trap 100 comprises a) a housing 200 and b) a mechanical and/or electrical killing device 300 (FIG. 2) positioned within the housing 200. The housing 200 is here shown configured as an open-ended tunnel. The open-ended tunnel 200 is configured and sized to allow a rat and/or mouse to pass from one end to the other. A rat and/or mouse entry opening 210 is partly positioned in the side wall 232, in an open end 234, and in the upper wall 236 of the open-ended tunnel (FIG. 2). The top entrance section of the rat and/or mouse entry opening 210 is lined with rows of serrated protrusions 212. A part of the side wall 220 is configured as a door 222 with a lock for restricted access to the killing device 300 located within the housing 200.

FIG. 2 is a side view of a poison-free rat and/or mouse trap in accordance with various embodiments of the invention, where a side wall (the door 222) of the housing has been removed. Here, it can be seen, that the killing means 310 of the mechanical and/or electrical killing device 300 is positioned at a level above the level of the rat and/or mouse entry opening 210. The position of the killing means 310 in relation to the rat and/or mouse entry opening 210 is crucial in order for the rows of serrated protrusions 212 to have any effect. When a larger pet, a child, or even a curious adult tries to force the paw/hand through the rat and/or mouse entry opening 210, the response of withdrawal is immediate due to the unpleasant palpable sensation of the serrated protrusions 212, thereby avoiding that the paw/hand reaches the killing means. Furthermore, the killing means of the mechanical and/or electrical killing device is positioned at a level above the level of the rat and/or mouse entry opening such that the rat and/or mouse can reach the killing means when standing within the housing on their hind legs. This configuration increases the number of times that a rat and/or mouse entering the trap will encounter the killing means.

The open-ended tunnel is configured with an open bottom, such that a rat and/or mouse within the open-ended tunnel is walking on the ground on which the poison-free trap is positioned. This configuration makes the rat and/or mouse to feel more safe, and thereby more prone to stay within the open-ended tunnel. The open-ended configuration allows the rat and/or mouse to see through the tunnel to the other side of the trap, whereby it will not hesitate entering the trap.

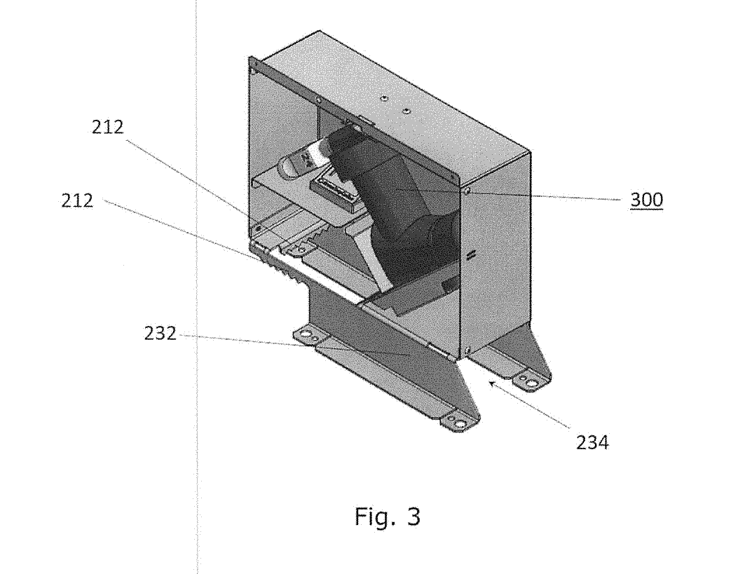

FIG. 3 is a perspective view of a poison-free rat and/or mouse trap in accordance with various embodiments of the invention, where a side wall of the housing has been removed. The shown killing device 300, is a gas driven device, where a killing piston is provided inside the trap housing and upon triggering of a trigger mechanism present in a cavity open for rat and/or mouse entry will propagate into the cavity of the trigger mechanism and, with a significant force, hit the rat and/or mouse that has activated the trigger mechanism. The rat and/or mouse is attracted to the cavity by bait present inside the killing device. Other types of traps or killing devices may however also be used.

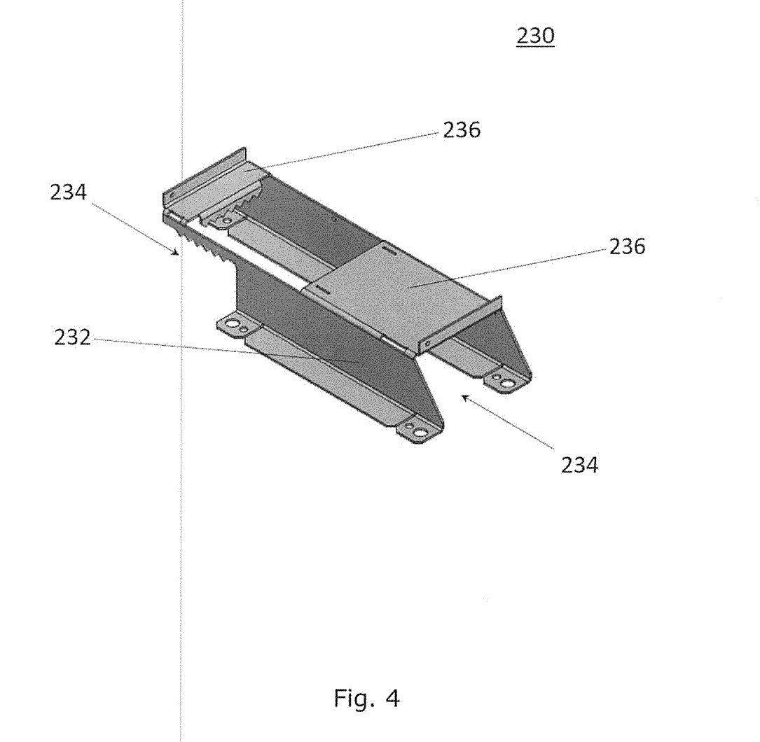

FIG. 4 is a perspective view of a bottom wall of the housing configured as an open-ended tunnel.

1. A poison-free rat and/or mouse trap (100) for placement on a surface of ground, the poison-free trap (100) comprising:
a housing (200) with a entry opening (210) positioned in a side wall (220) and/or in a bottom wall (230); and
a killing device (300) positioned within the housing (200); having a killing means (310) positioned at a level above a level of the entry opening (210), and wherein at least a part of the entry opening (210) is lined with one or more rows of serrated protrusions (212).

2. The poison-free trap (100) according to claim 1, wherein the bottom wall (230) of the housing (200) is configured as an open-ended tunnel configured and sized to allow a rat and/or mouse to pass from one end to another end; wherein the entry opening (210) is positioned in the side wall (232), an open end (234), or a upper wall (236) of the open-ended tunnel.

3. The poison-free trap (100) according to claim 2, wherein the open-ended tunnel is configured with an open bottom, such that a rat and/or mouse within the open-ended tunnel is walking on the ground on which the poison-free trap is positioned.

4. The poison-free trap (100) according to claim 2, wherein the entry opening (210) is positioned in both the side wall (232) and in an open end (234) of the open-ended tunnel.

5. The poison-free trap (100) according to claim 1, wherein the killing means (310) of the killing device (300) is positioned at a level above a level of the entry opening such that a rat and/or mouse can reach the killing means (310) when standing within the housing (200) on their hind legs.

6. A The poison-free trap (100) according to claim 1, wherein the entry opening (210) and the one or more rows of serrated protrusions (212) are sized and configured to leave an opening with a free height of at least 40 mm.

7. A The poison-free trap (100) according to claim 1, wherein entry opening (210) and the one or more rows of serrated protrusions (212) are sized and configured to leave an opening with a clear width of at least 40 mm.

8. A The poison-free trap (100) according to claim 1, wherein at least a top entrance section of the entry opening (210) is lined with one or more rows of serrated protrusions (212).

9. The poison-free trap (100) according to claim 1, wherein the killing device is a gas cartridge operated device.

10. The poison-free trap (100) according to claim 1, wherein the poison-free trap (100) further comprises means for securing the housing to the ground and/or to a wall near the ground, to avoid the trap from being turned on its side.
